(19) United States
(12) Patent Application Publication
(10) Pub. No.: US 2020/0309082 A1
(43) Pub. Date: Oct. 1, 2020

(54) System and Method for Accommodating Nitrous Oxide in Conventional Engine ECUs

(71) Applicant: Mario Mikha, Chandler, AZ (US)

(72) Inventor: Mario Mikha, Chandler, AZ (US)

(21) Appl. No.: 16/363,868

(22) Filed: Mar. 25, 2019

(51) Int. Cl. F02P 5/15; F02P 5/04; F02B 43/10

(52) U.S. Cl. CPC F02P 5/151; F02B 43/10; F02P 5/045

(57) ABSTRACT

A nitrous oxide (N₂C) air intake control module for conventional vehicle engines is disclosed. The invention essentially being comprised of a plugin module that masks the engine's existing cold air intake temp sensor data being sent to the engine control unit (ECU) to accommodate N₂O injection systems. Said device lowering engine emission timing to accommodate the higher N₂O temperatures thereby enhancing the ignition and combustion sequences normally designed for gasoline. An object of the invention is to prevent ‘early detonation’ or ‘pre-ignition’ (due to higher temperatures associated with the use of N₂O) thereby maintaining the benefit of increases in power while minimizing excessive wear on an engine

### FIELD OF THE INVENTION

The present invention generally relates to vehicle engines. More specifically, it relates to a retrofit kit that over-rides an engine's conventional air intake sensor to accommodate N₂O inputs into the system.

### BACKGROUND

A N₂O boost is an additive to engines in which oxygen for burning the fuel also comes from the decomposition of nitrous oxide, N₂O (in addition to ambient air). The system increases the engine's power output by allowing fuel to be burned at a higher-than-normal rate, because of the lighter partial pressure of oxygen injected within the fuel mixture. N₂O injection systems were first used in World War II for certain aircraft engines and the German Luftwaffe adapted such systems for planes that included high altitude reconnaissance aircraft, high speed bombers and high-altitude interceptors. The British also used NOS injector systems in their Merlin engines manufactured by the Heston Aircraft Company for use in certain night fighter variants of their ‘De Havilland Mosquito’ and their ‘Supermarine Spitfire.’ The use of N₂O became popular in automobile racing in the 1950s because it allowed the engines to bum more fuel by providing more oxygen than air alone, resulting in a mote powerful combustion. The gas is not flammable at a low pressure and temperature, but it delivers more oxygen than atmospheric air by breaking down at elevated temperatures. The N₂O is stored as a compressed liquid and the evaporation and expansion of liquid nitrous oxide in the intake manifold causes a large drop in intake charge temperature, resulting in a denser charge, further allowing more air/fuel mixture to enter the cylinder. Sometimes nitrous oxide is injected into the intake manifold, whereas other systems directly inject, right before the cylinder to increase power. Conventional N₂O injection systems may be ‘dry’ (N₂O injected separately from fuel), or ‘wet’ (gasoline is carried into the engine along with N₂O). N₂O systems may not be permitted tor street use—but it is permitted in certain classes of auto racing and is often used by off-road enthusiasts for overcoming challenging terrain. The automotive industry has been working with vehicle controller technologies to enhance N₂O intakes. United States Patent No. US20040079332 adapt* conventional engines for n2o but does so downstream of the air intake. U.S. Pat. No. 5,287,281 adjusts fuels at the engine's fuel injectors and does not manipulate the intake temperature of an engine. U.S. Pat. No. 5,269,273A adjusts engine intake temperatures by means of pulse width modulation and docs not use a resistor. German Patent No. DE112011103078B4 enhances the system by means of electromechanical system and not adjusting the air intake temperature electronically.

### SUMMARY OF THE INVENTION

The device herein disclosed and described provides a solution to the shortcomings in the prior art through the disclosure of a N₂O air intake control module for conventional vehicle engines. An object of this invention is to provide a means to increase power in conventional engines over short periods of time. For example, a conventional off-road vehicle encounters an extremely steep grade and does not have the horsepower to overcome the terrain. The user can simply flip a switch, activate the unit and receive a N₂O boost providing the vehicle with extra power to overcome the obstacle.

Another object of the invention is to minimize operational complications when introducing N₂O into an engine. For example, balancing air intake into an engine is in modern vehicles is achieved by hearing a wire with an electric current suspended in the engine's air scream, not unlike a toaster wire. The wire's electrical resistance increases as the wire's temperature increases, which limits electrical current flowing through the circuit. When air flows past the wire the wire cools, decreasing its resistance, which in turn allows more current to flow through the circuit. As more current flows, the wire's temperature increases until the resistance reaches equilibrium again. The aforementioned system provides data to the vehicle's ECU which then allows the combustion processes to adapt to the intake air and ensure smooth operation. However, when N₂O is introduced into the intake, the ECU may not recognize the condition and can interrupt normal engine functioning. When the control module in this disclosure is installed on an engine intake, the device will send the proper signal the ECU thereby reducing the opportunity for interruptions such as pre-ignitions. This reduction in pre-ignitions can lead to less opportunities backfire occurrences within the engine associated with manual N₂O intake bypass methods used on older vehicles.

Another object of the aforementioned invention is to provide a means to allow a user to easily and quickly install the device on many conventional, commercial vehicles currently on the market today. The device is comprised of a small module, a wiring harness and a terminal connector compatible with most vehicle harnesses.

Another object of the invention is to provide a means to replace existing, analog, air temperature signals to the ECU with a virtual, digital signal that allows the engine to accommodate the N₂O while minimizing engine interruptions. The module contains a small microcontroller with onboard memory that bypasses the original signal and replaces it with a consistent, digital signal value that is compatible with ECU handshaking inputs. The ECU easily recognizes the new signal and applies commands to receive the N₂O based on its internal ‘look up table data’ accordingly.

It is briefly noted that upon a reading this disclosure, those skilled in the art will recognize various means for carrying out these intended features of the invention. As such it is to be understood that other methods, applications and systems adapted to the task may be configured to carry out these features and are therefore considered to be within the scope and intent of the present invention, and are anticipated. With respect to the above description, before explaining at least one preferred embodiment of the herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed device. It is important, therefore, that the claims be regarded as including such equivalent construction and methodology insofar as they do not depart from the spirit and scope of the present invention. As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements arc optional and may or may not be present depending upon whether or not they affect the activity or action of the listed elements.

The objects features, and advantages of the present invention, as well as the advantages thereof over existing prior art, which will become apparent from the description to follow, are accomplished by the improvements described in this specification and hereinafter described in the following detailed description which fully discloses the invention, but should not be considered as placing limitations.

### BRIEF DESCRIPTION OF THE FIGURES

The accompanying drawings, which are incorporated herein and form a part of the specification, illustrate some, but not the only or exclusive, examples of embodiments and/or features.

FIG. 1 shows a perspective view of the invention.

FIG. 2 illustrates a side view of the invention installed on a conventional engine.

FIG. 3 shows a wiring diagram of the invention.

FIG. 4 shows a representative view of the invention process.

Other aspects of the present invention shall be more readily understood when considered in conjunction with the accompanying drawings.

### DETAILED DESCRIPTION OF FIGURES

In this description, the directional prepositions of up, upwardly, down, downwardly, front, back, top, upper, bottom, lower, left, right and other such terms refer to the device as it is oriented and appears in the drawings and are used for convenience only; they are not intended to be limiting or to imply that the device has to be used or positioned in any particular orientation.

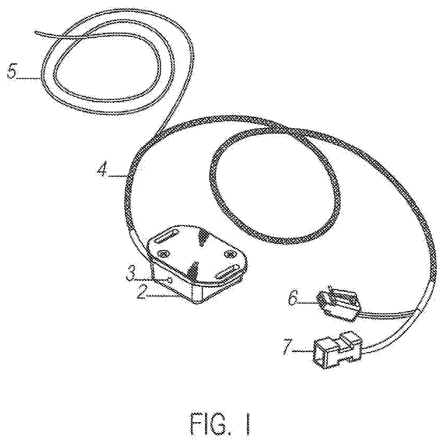

FIG. 1 shows a perspective view of invention 1 comprised of box-shaped, case 2 (being made of a rigid, material such as bur nor limited to plastic, metal and the like) having two parts being affixed together by means of fasteners and having light emitting diode (LED) thereon. Invention 1 housing a control unit (to be introduced further in this document) therein and having wiring harness 4 comprised of power lead 5, ECU connection 7 and intake engine sensor 6 extending from distal ends of said case 2.

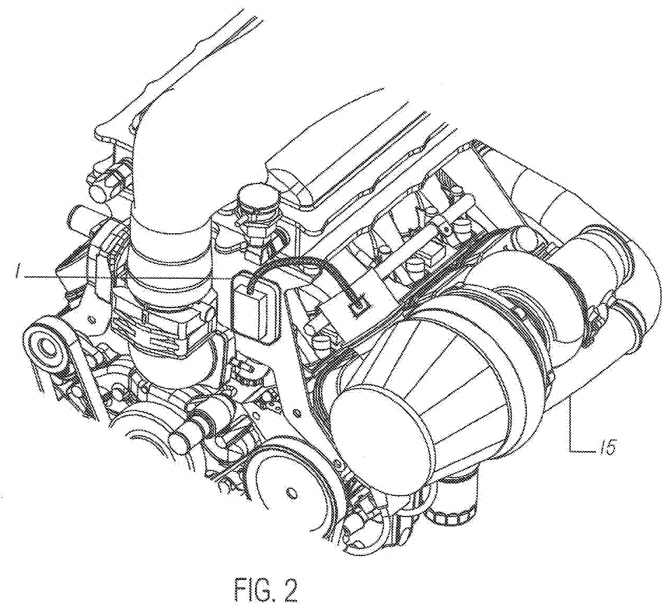

FIG. 2 illustrates a side view of invention 1 installed on a conventional engine 15. In certain embodiments, power lead 5 connecting to the vehicles 12 volt battery power source. ECU connection 7 configured to engage conventional engine ECU harnesses allowing temperature signals to be replaced therein, and engine sensor 6 being connected to an engine's existing, conventional temperature sensor.

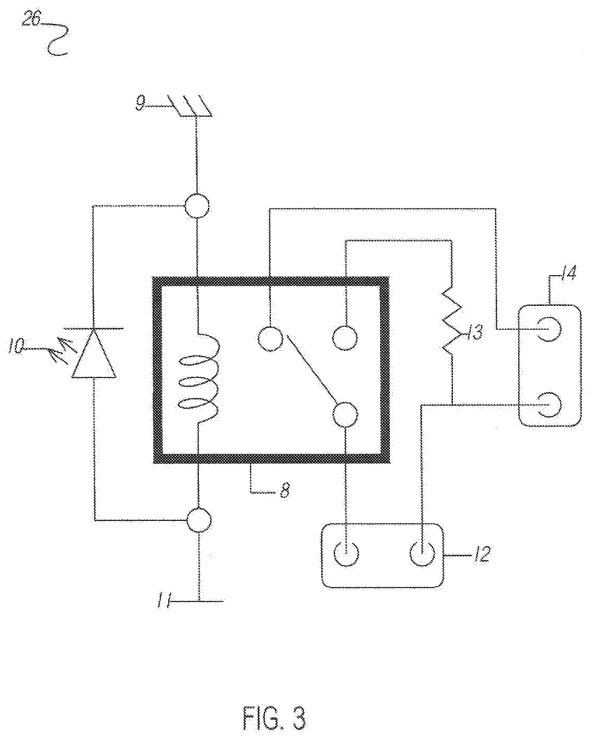

FIG. 3 shows a wiring diagram of invention 1's control unit 26 with voltage supply source 11 energizing SPDT relay 8 and LED 10 and thereby activating switching inside said relay. Said switching allowing invention 1 to alter temperature signal coming from temperature, sensor 12 by means of resistor 13 and sending new temperature signal (such as but not limited to 200 degrees Fahrenheit and the like) to the engine ECU by means of ECU connection 7. The aforementioned control unit also being grounded by means of chassis ground 9.

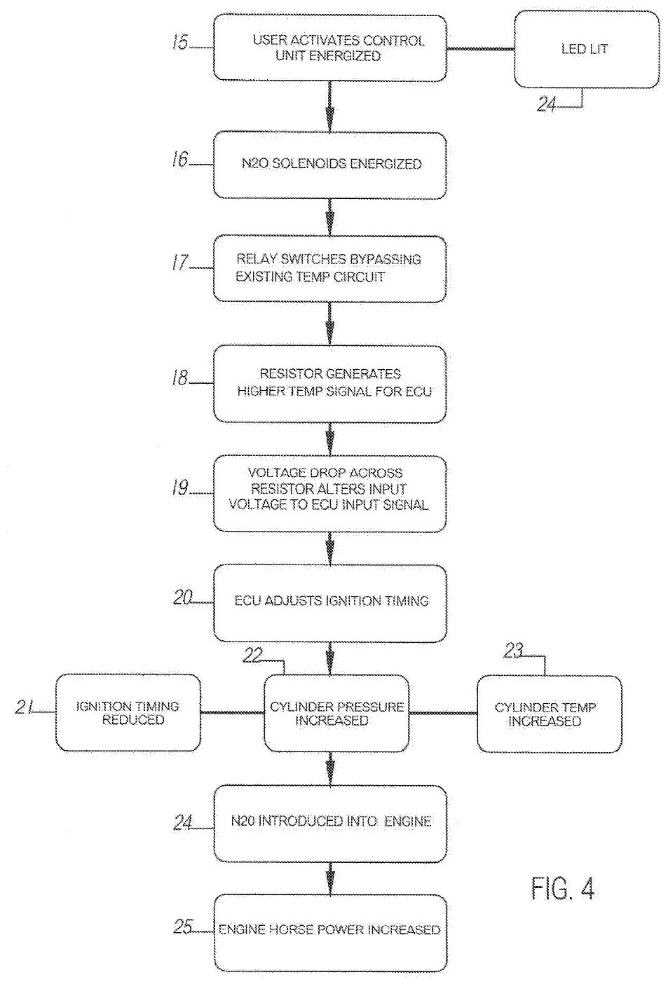

FIG. 4 shows a representative view of the invention process with a user activating the device and energizing the control unit in step 15 thereby lighting LED in step 24, energizing N₂O solenoid in step 16, allowing the relay to bypass an engine's existing temperature circuit in step 17 and causing the resistor to generate a higher temperature reading for the engine's ECU. The new signal being sent to engine ECU in step 19 and adjusting ignition timing in step 20. The resulting change in engine timing also decreasing ignition timing in step 21, and increasing cylinder pressure in step 22 and cylinder temperature in step 23 as N₂G is introduced into engine in step 24. The result of these steps culminating in increased engine horsepower in the final step 25.

It is additionally noted and anticipated that although the device is shown in its most simple form, various components and aspects of the device may be differently shaped or slightly modified when forming the invention herein. As such those skilled in the art will appreciate the descriptions and depictions set forth in this disclosure or merely meant to portray examples of preferred modes within the overall scope and intent of the invention, and are not to be considered limiting in any manner. While all of the fundamental characteristics and features of the invention have been shown and described herein, with reference to particular embodiments thereof a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled ill the art without departing from the spirit or scope of the invention.

What is claimed is:

1. An air intake temperature bypass for conventional vehicle engines is disclosed and is comprised of the following parts:
(a) a ease;
(b) a power lead;
(c) a temperature sensor connection;
(d) a ground;
(d) an ECU connection; and
(e) a control unit.

2. The control unit of claim 1 having a relay.

3. The control unit of claim 1 having a resistor.

4. The control unit of claim 1 having an LED.

5. A method for increasing horse power in a conventional vehicle engine, the method comprising:
(a) fitting onto conventional engine's temperature sensor and ECU connections;
(b) bypassing an existing temperature sensor reading;
(c) replacing an engine's temperature sensor reading; and
(d) sending a new temperature sensor reading to an engine's ECU.
